(19) United States
(12) Patent Application Publication
(10) Pub. No.: US 2017/0012281 A1
(43) Pub. Date: Jan. 12, 2017

(54) LITHIUM BATTERY CATHODE MATERIALS THAT CONTAIN STABLE FREE RADICALS

(71) Applicant: DOW GLOBAL TECHNOLOGIES LLC, Midland, MI (US)

(72) Inventors: Wenjuan LIU, Baltimore, MD (US); John W. KRAMER, Midland, MI (US); Koichi NUMATA, Midland, MI (US)

(21) Appl. No.: 15/114,822

(22) PCT Filed: Mar. 25, 2015
(86) PCT No.: PCT/US2015/022379

§ 371 Date: Jul. 27, 2016

Related U.S. Application Data
(60) Provisional application No. 61/971,689, filed on Mar. 28, 2014.

(51) Int. Cl. H01M 4/36; H01M 4/04; H01M 10/0525; H01M 4/505; H01M 4/525

(52) U.S. Cl. CPC H01M 4/366; H01M 4/505; H01M 4/525; H01M 10/0525; H01M 4/0409; H01M 4/0471; H01M 2004/028

(57) ABSTRACT

Lithium transition metal cathode materials are functionalized with a stable free radical such as a nitroxide free radical. The stable free radical may be bonded directly to the cathode material or to a coating, such as a polymeric coating, on the surface of particles of the lithium transition metal cathode material. The functionalized cathode materials perform very well as lithium battery cathodes.

Lithium batteries are widely used to power electronics, hybrid vehicles, medical devices and a wide range of other electric power devices. Lithium batteries tend to have high energy and power densities, which give them advantages over many other types.

Lithium batteries typically have a cathode that includes a lithium transition metal oxide or lithium transition metal phosphate as the electroactive material. The anode can be graphite, for example. As with other types of batteries, the anode and cathode are in contact with an electrolyte solution. The electrolyte is a lithium salt that is dissolved in a solvent. The solvent is by necessity a nonaqueous type. Various linear and cyclic carbonates are commonly used as the solvent, but certain esters, alkyl ethers, nitriles, sulfones, sulfolanes, sultones and siloxanes may also serve as the solvent. In many cases, the solvent may contain two or more of these materials. Polymer gel electrolyte solutions are also known.

There is a need to improve the cycling performance of lithium batteries. The discharge capacity and often the mean operating voltage of lithium batteries degrade as the batteries are put through a number of charge-discharge cycles. The rate at which the performance degrades relates directly to battery life.

In addition, the organic-based electrolyte solutions are sensitive to high temperatures. They may decompose, engage in runaway exothermic reactions or even burn if exposed to the wrong conditions. Lithium batteries have been known to catch fire due to overcharge, overdischarge, short circuit conditions, and mechanical or thermal abuses.

These problems are caused by a number of irreversible changes that occur within the cell. The exact nature of these changes is not completely understood in all cases. They may include, for example, decomposition reactions of the lithium salt; chemical reactions of the cathode material itself, and possible leaching of materials from the cathode material into the electrolyte solution. Electrochemical reactions involving the electrolyte solvent are believed to be another contributing factor. At least some of these events are believed to take place at the interface between the cathode material and the electrolyte.

One approach to ameliorating these problems has been to coat the cathode material with a protective or passivating layer. Inorganic materials such as aluminum oxide, zirconium oxide, titanium oxide, boron oxide and various metal phosphates as well as various organic polymers have been tried as the coating material. The coating material forms a physical barrier between the cathode material and the electrolyte solution. This barrier is believed to improve battery life by reducing the incidence of irreversible changes that occur at the cathode/electrolyte interface.

Some benefits have been seen with the coating approach, but these often come at a cost. The performance of the battery depends on ion transport to and from the cathode material as the battery is charged and discharged. The coating material can impede this ion transport from the electrolyte solution to and from the cathode material. This in turn hurts battery performance, especially performance at high discharge rates.

What is desired is a way to provide a lithium battery that has good cycling stability and good high temperature stability, yet exhibits good rate performance.

This invention is in one aspect a particulate cathode material comprising particles of an electroactive lithium transition metal cathode material, the particles having stable free radical groups bonded to the lithium transition metal cathode material and/or to a coating on the surface of the particles.

The invention is in another aspect a battery cathode comprising the particulate cathode material of the invention.

The invention is in another aspect a lithium battery comprising an anode, a battery cathode of the invention, a separator disposed between the anode and cathode, and an electrolyte solution containing at least one lithium salt, said electrolyte solution being in contact with the anode and cathode.

The cathode material provides significant benefits when used as a cathode material in a lithium battery. These benefits are especially evident at high (>4.3, especially 4.4-4.7V or even 4.6-4.7V) conditions. The battery impedence is surprisingly low, especially after multiple charge/discharge cycles. These benefits indicate that the stable free radicals are providing significantly improved ion transport during battery operation. At least in cases in which the free radicals are bonded to a coating on the cathode particles, the cathode material of the invention provides significantly better cycling stability than otherwise like conventional cathode materials that lack the stable free radical groups, with better maintenance of both average voltage and specific capacity as the battery is operated through many charge/discharge cycles. This indicates the polymer coating with its bonded free radicals is protecting against unwanted reactions at the interface between the cathode material and the electrolyte solution.

The invention is in another aspect a method for making a particulate cathode material, comprising applying a coating having stable free radical groups or stable free radical precursor groups onto the surface of particles that contain an electroactive lithium transition metal cathode material and then converting any stable free radical precursor groups to stable radical groups.

The invention is in another aspect a second method for making a particulate cathode material, comprising:

a) applying a coating having first functional groups onto the surface of particles that contain an electroactive lithium transition metal cathode material and

b) reacting the coating with a functionalized stable free radical compound having a stable free radical or a free radical precursor group and a second functional group, wherein the first functional group and the second functional group react to bond stable free radical groups or free radical precursor groups to the coating, and then converting any free radical precursor groups to stable free radical groups.

Suitable lithium transition metal cathode materials include, for example, lithium cobalt oxides including those whose composition is approximately LiCoO2, lithium nickel composite oxides including those whose composition is approximately LiNiO2, and lithium manganese composite oxides including those whose composition is approximately LiMn₂O₄ or LiMnO₂. In each of these cases, part of the cobalt, nickel or manganese can be replaced with one or more metals such as Al, Ti, V, Cr, Fe, Co, Ni, Cu, Zn, Mg, Ga or Zr. Lithium transition metal composite phosphates include lithium iron phosphates (such as LiFePO4), lithium iron phosphate fluorides (such as LiFePO₄F), lithium manganese phosphates (including LiMnPO₄), lithium cobalt phosphates (such as LiCoPO₄), lithium iron manganese phosphates, and the like.

Among the suitable cathode materials are the so-called lithium-rich layered oxide materials (LRMs) that are described, equivalently, by the notations xLi2MnO₃. (1−x) LiMO₂ and Li_{1+(x/(2+x))}(M′₁₋₍₂₊ₓ₎₎O₂ (M′=Mn+M), wherein M is one or more third row transition metals such as Mn, Ni, Co, Fe and Cr.

The lithium transition metal cathode is in the form of particles. The particles suitably have an average longest dimension of up to 20 μtm. Smaller particles are preferred. The particles preferably have an average longest dimension of up to 5 μm, and more preferably up to 500 nm, still more preferably up to 200 nm.

The cathode material or a coating on the cathode material particles contains stable free radical groups, i.e. a group that includes a stable free radical. A free radical is an uncharged species having an unpaired electron. For purposes of this invention, the free radical is “stable” if it does not engage in irreversible reactions during the charge and discharge cycles of a battery containing a cathode that includes the cathode material. The free radical is believed to undergo a reversible loss of the unpaired electron during a battery charge cycle, thus forming a cation. The cation is believed to reversibly recover the unpaired electron during a battery discharge cycle to regenerate the free radical.

Preferably the free radical is electrochemically activated (i.e., loses the unpaired electron to form a cation) at a lower voltage than that at which the cathode material becomes activated.

The free radical group may be, for example, a triphenyl methyl radical, a perchlorotriphenylmethyl radical, a 2,2-diphenyl-1-picrylhydrazyl group, a nitroxide radical, a nitronyl nitroxide radical, a 1-oxy-2,4,6-tris(t-butyl)phenyl radical, galvinoxyl, and the like, in each case bonded to the coating or to the cathode material.

Nitroxide free radical groups are particularly useful. By “nitroxide free radical group” is it meant a group including an oxygen atom singly bonded to a nitrogen atom and having an unpaired electron, which typically resides on the oxygen atom. The nitrogen atom is typically bonded to two carbon atoms in addition to the nitroxide oxygen. The nitroxide free radical groups are stable at room temperature in the absence of an applied voltage. In the presence of an applied voltage such as 2 to 4 volts, the nitroxide radical can lose the unpaired electron and form a cation. In its cationic form, the nitroxide radical increases the electron and ion conductivities of the coating.

Suitable nitroxide free radical groups include those represented by the general structure I:

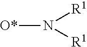

wherein each R¹ group is independently an alkyl, substituted alkyl, aryl or substituted aryl group, provided that the R¹ groups together may form a ring structure that includes the nitrogen atom within the ring structure. The two R¹ groups can be the same or different. At least one of the R¹ groups includes or forms part of the organic polymer.

In some embodiments, at least one of the R¹ groups is bound to the nitrogen atom through a tertiary carbon atom (i.e., a carbon atom bonded to three other carbon atoms in addition to the nitrogen atom). Both of the R¹ groups may be bound to the nitrogen atom through tertiary carbon atoms. In other embodiments, one of the R¹ groups is bound to the nitrogen atom through a tertiary carbon atom, and the other of the R¹-groups is bound to the nitrogen atom though an aryl (preferably phenyl)-substituted carbon atom.

The R¹ groups may contain various substituent groups, including ether and nitrile groups, that do not react with the free radical.

Examples of nitroxide radical groups include, for example, those described by Hawker et al., “New Polymer Synthesis by Nitroxide Mediated Living Radical Polymerizations”, Chem. Rev. 2001, 101, 3661-3668, in each case being bonded to the coating or to the cathode material.

In some embodiments the R¹ groups together with the nitrogen atom form a pyrrolidinyl or piperidinyl ring in which the carbons bonded to the nitrogen atom (at the ring positions typically designated the 2- and 5- positions in the case of pyrrolidinyl and the 2- and 6- positions in the case of piperidinyl, with the 1-position being the nitrogen atom) each are di-substituted, with the substituent groups preferably being in each case alkyl, especially methyl. In such embodiments, the pyrrolidinyl or piperidinyl ring is bonded to the polymer through one of the carbon atoms on the pyrrolidinyl or piperidinyl ring. For example, one or more of the substituents on the 2- and or 5-carbons (in the case of pyrrolidinyl) or 2- and/or 6-carbons (in the case of piperidinyl) may include the organic polymer.

A specific example of a suitable nitroxide free radical group is a 2,2,6,6-tetramethylpiperidine 1-oxyl (TEMPO) group, which when bonded to the cathode material or a coating has the structure:

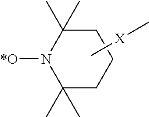

wherein X represents a covalent bond or linking group between any of the carbon atoms and the cathode material and/or coating. If a linking group, X may be, for example, alkylene, amido, ester, ether, urea, urethane, carbonate, siloxane, imine, amino or other linkage, and may be a moiety that contains two or more of such groups.

Other useful nitroxide groups include those that have the following structures:

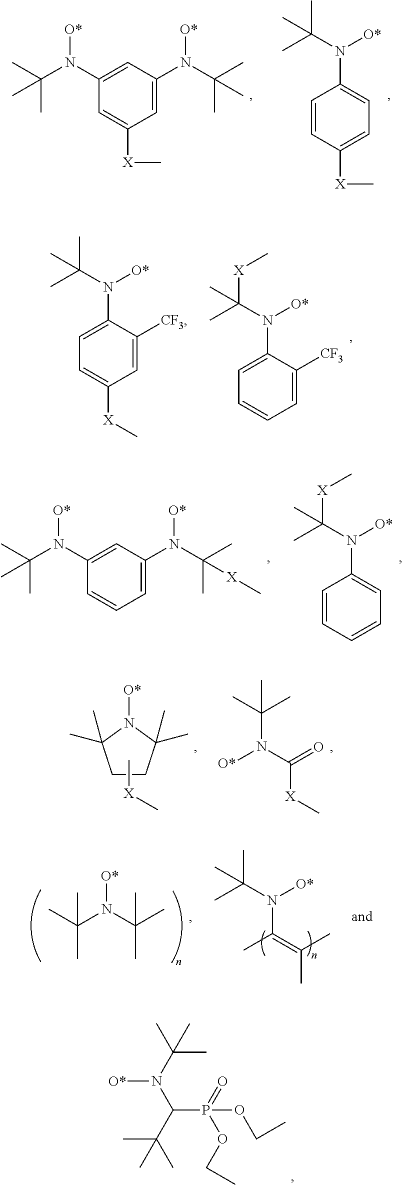

where X is as defined before and n represents the degree of polymerization. Where not indicated, the bond to the cathode material and/or coating may be with any carbon atom in the structure.

A free radical precursor group is a group that can be converted to a stable free radical group. Typically, the free radical precursor group will contain a moiety that can dissociate to produce the stable free radical and a leaving group which can be removed. For example, certain alkoxyamines dissociate to form stable nitroxide radicals. Suitable alkoxyamines include those represented by structure II:

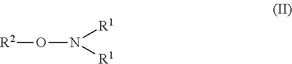

wherein each R¹ is independently as described with respect to structure I, and R² is hydrogen, alkyl or substituted alkyl. The R² group may in some cases be bonded to the nitroxide oxygen atom through a tertiary carbon atom, an allylic carbon (i.e., one alpha to a vinyl or substituted vinyl group) or a benzyl carbon atom (i.e., an aliphatic carbon atom bonded directly to an aromatic ring). Examples of R² groups include, for example, H,

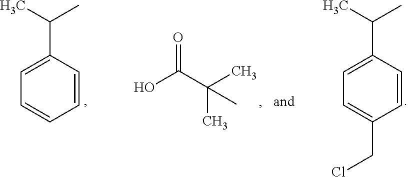

Any of these R² groups can be, for example, bonded to any of the nitroxide compounds described above to form the corresponding alkoxyamine.

Other suitable alkoxyamines include those described by Ma et al., Chemical Engineering Society 58 (2003) 1177-1190, and by Bartsch et al., Macromol. Rapid Commun. 2003, 24, 614.

Another type of free radical precursor is a compound having the structure

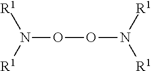

wherein each R¹ is as described above. Each R¹ can be the same or different. Compounds of this type dissociate to produce two stable nitroxide radicals.

In some embodiments of the invention, some or all of the stable free radical groups are bonded to a coating on the surface of the particles of the cathode material. The coating can be any type of material which is capable of being formed as a coating on the cathode material particles, and which is thermally, chemically and electrically (with the exception of the nitroxide radical) stable under the conditions of used, including, for example, the electrical voltages to which the cathode material is to be subjected during use and to the battery operating temperatures. The coating may be, for example, an inorganic coating, an organic coating, or an inorganic-organic hybrid material. A preferred type of coating material is an organic polymer.

The polymer is one that can be formed into a coating on the surface of the particles of the cathode material. The polymer should not be soluble in or reactive with the electrolyte solution, or any component thereof.

The polymer may be, for example, an organic polymer, a polysiloxane polymer or copolymer, or an organic-inorganic hybrid polymer. Examples of organic polymers include, for example, polyolefins, poly(vinyl aromatic) polymers and copolymers, polyesters, polyamines, polyurethanes, polyureas, polyisocyanurates, polyamides, polyimides, polysulfones, polyethers, cured epoxy resins, polymers and copolymers of one or more acrylate esters, polyacrylic acid polymers and copolymers, and the like.

The polymer may be crosslinked if desired to form a continuous polymeric network at or near the surface of the particles.

The polymer may have, for example, an equivalent weight per nitroxide radical of, for example, 300 to 10,000, 400 to 2,000, or 500 to 1200 grams/equivalent.

The coating is preferably as thin as possible so that acceptable ion and electron conduction is achieved. The weight of the polymer coating may be, for example, from 0.1 to 50 percent, more preferably 0.15 to 2.5%, still more preferably 0.2 to 1.5% and even more preferably 0.25 to 1% of the weight of the uncoated cathode particles.

A coating of a polymer having stable free radical groups can be formed in different ways, which may depend in part on the polymer type. In one approach, a polymer having stable free radical groups is applied to the particles in the form of a solution in a suitable solvent, and the solvent is subsequently removed, leaving a polymer coating on the particle surfaces. The solvent should not dissolve, react with or otherwise modify the cathode material, the stable free radicals and any coating as may be present, and should be more volatile than the polymer. Dilute solutions are generally preferred, because the lower viscosity of dilute solutions facilitates the formation of a thin and uniform coating, and also helps to reduce or prevent particle agglomeration. In this method, the particulate cathode material and the polymer solution are mixed using any convenient method to coat the particles with the solution. The coated particles can then be dried at ambient conditions, or at elevated temperature and/or subatmospheric pressure, to remove the solvent and produce the polymer coating. The polymer may be crosslinked or chain-extended after application, if desired.

In a variation of this approach, the polymer has free radical precursor groups. After the polymer is coated onto the particle surfaces, an additional step of converting the free radical precursor groups to stable free radical groups is performed. The free radical precursor groups often decompose thermally to produce stable free radicals; in such as case, the conversion step can be a heating step, which may be performed at subatmospheric pressure and/or under a sweep gas to remove unwanted decomposition products.

In another variation of this approach, the organic polymer is formed by contacting the cathode material particles with one or more polymer precursor compounds, which react at the surface of the cathode material particles to form the organic polymer. At least one precursor includes a stable free radical precursor group or a free radical precursor group. The polymer precursor(s) typically are low (less than 1000 g/mol) molecular weight compounds that often are low in viscosity, which facilitates the coating process. If desired, the precursors can be supplied in solution in a solvent as described before, which can further reduce viscosity.

Examples of polymer precursors include, for example, monomers having polymerizable carbon-carbon double bonds, including, for example, olefins, vinyl aromatic monomers, acrylate monomers and the like, and conjugated diene monomers. Other useful polymer precursors include precursors of polyurethane, polyurea and/or polyisocyanurate polymers, which typically include at least one polyisocyanate compound and at least one curing agent that includes hydroxyl and/or primary or secondary amino groups. Other useful precursors include cyclic monomers that polymerize in a ring-opening polymerization, including, for example, cyclic ethers, cyclic amines, cyclic esters, cyclic lactams, cyclic carbonates and the like. Other useful precursors include trialkoxy silane and trichlorosilane compounds. In this first method, at least one precursor has a stable free radical group or a free radical precursor group as described before.

In a second method, a coating of the polymer is applied onto the surface of the cathode material particles and stable free radical groups are introduced onto the polymer. The polymer coating can be applied from solution or by the reaction of one or more polymer precursors as described before, provided that the polymer or at least one precursor has first functional groups. After the polymer coating is applied, the first functional groups are reacted with a functionalized stable free radical compound. The functionalized stable free radical compound has a stable free radical or a free radical precursor group and a second functional group. The first and second functional groups react to form a bond which attaches the stable free radical groups or free radical precursor groups to the polymer. Any free radical precursor groups are then converted to stable free radical groups as before.

Examples of pairs of first and second functional groups include, for example, a carboxylic acid, carboxylic acid anhydride, ester, or carboxylic acid halide and a primary or secondary amino group or hydroxyl group; a hydroxyl, primary amino or secondary amino group and an isocyanate group or an anhydride group; a Michael donor group and a Michael acceptor group; a thiol group and an ene group; a primary amino, secondary amino, phenol or thiol group with an epoxy group; a silane and a vinyl-containing group, and the like. Either one of such pair may be present on either the polymer or the functionalized stable free radical compound.

In certain embodiments of the invention, the polymer coating is a partially or fully imidized polyimide having attached stable nitroxide free radicals. Such a partially or fully imidized polyimide can be produced in a condensation of a dianhydride and an aromatic diamine. In some embodiments, the dianhydride and diamine each are aromatic. Preferably, the dianhydride and aromatic diamine are partially condensed to form an intermediate polymer known as a polyamic acid. The polyamic acid is soluble in polar solvents and so is conveniently applied to the cathode material particles as a solution. The polyamic acid has residual carboxylic acid groups and amido groups that can react to form additional imide linkages, thus forming an imidized polymer that has excellent thermal stability and which has low solubility in most solvents. Before the polyamic acid is fully imidized, the carboxyl acid groups and the amido groups each represent first functional groups which can be used to bond to a second functional group of a functionalized stable free radical compound.

Thus, in a particular embodiment, a polyamic acid coating is applied to the cathode material particles. A functionalized stable free radical compound, preferably a functionalized nitroxide radical or functionalized alkoxyamine as described above, is then reacted with a portion of the carboxylic acid groups and/or amido groups to introduce stable free radical groups or free radical precursor groups. Some or all of the remaining carboxylic acid and amido groups are imidized to form a polyimide. If necessary, free radical precursor groups are converted to stable free radical groups. In this embodiment, it is preferred to partially imidize the polyamic acid before the stable free radical groups or free radical precursor groups are introduced. In this case, the functionalized stable free radical compound is then reacted with some or all of the remaining carboxyl or imido groups, and some or all of the remaining carboxyl and amido groups may then be imidized.

A preferred polyamic acid is a condensation product of pyromellitic dianhydride and 4,4′-oxydiphenylamine. Such a polyamic acid product is commercially available, for example, from DuPont under the trade names Kapton™ K and Kapton™ HN.

Imidization can be performed by heating the polyamic acid-coated cathode material particles to an elevated temperature, preferably under an inert atmosphere such as nitrogen, helium and/or argon. The imidization temperature can be, for example, 50 to 400° C. The extent of imidization is controlled primarily through time and temperature.

In a preferred embodiment, the polyamic acid coating is imidized to the extent of about 25 to 90% (i.e., 25 to 90% of the carboxylic acid groups are reacted with amido groups to form imides). The extent of imidization can be followed analytically if desired, but at industrial scale the necessary time and temperature conditions needed to obtain a desired amount of imidization can be determined empirically. After partial imidization, a functionalized stable free radical compound is then contacted with the coating under conditions that the functionalized stable free radical compound reacts with some or all of the remaining carboxylic acid and/or amido groups. If any carboxylic acid groups remain after this step, the polymer may be further imidized to consume some or all of those carboxylic acid groups. If necessary, conversion of any free radical precursor groups, such as alkoxyamine groups, to stable free radicals, can be performed before, during or after the final imidization.

The second functional group on the functionalized stable free radical compound preferably reacts with carboxylic acid groups on the polyamic acid (or partially imidized polyamic acid). The second functional group may be, for example, a hydroxyl group or other group that forms a bond to the carboxylic acid group, but a preferred second functional group is preferably a primary or secondary amino group. Thus, a preferred functionalized stable free radical compound contains at least one primary or secondary amino group. An especially preferred functionalized stable free radical compound includes at least one primary or secondary amino group, and a stable nitroxide free radical or an alkoxyamine group that is convertible to a stable nitroxide free radical.

An example of such an especially preferred functionalized stable free radical compound is 4-amino-2,2,6,6-tetramethyl piperadine 1-oxyl.

The cathode material of the invention can be formed into a cathode using any convenient method. Suitable methods for constructing lithium ion battery electrodes include those described, for example, in U.S. Pat. No. 7,169,511. The electrodes are each generally in electrical contact with or formed onto a current collector. A suitable current collector for the anode is made of a metal or metal alloy such as copper, a copper alloy, nickel, a nickel alloy, stainless steel and the like. Suitable current collectors for the cathode include those made of aluminum, titanium, tantalum, alloys of two or more of these and the like.

Typically, particles of the cathode material are combined with a binder and pressed to form the cathode. Other ingredients can be included within the cathode, including those described below.

The binder is generally an organic polymer, such as a poly(vinylidene fluoride), polytetrafluoroethylene, a styrene-butadiene copolymer, an isoprene rubber, a poly(vinyl acetate), a poly(ethyl methacrylate), polyethylene, carboxymethylcellulose, nitrocellulose, 2-ethylhexylacrylate-acrylonitrile copolymers, and the like. The binder is generally nonconductive or at most slightly conductive.

An electrode can be assembled from the binder and the electrode particles in any convenient manner. The binder is typically used as a solution or in the form of a dispersion (as in the case of a latex). In many cases, the binder can simply be mixed with the electrode particles, formed into the appropriate shape and then subjected to conditions (generally including an elevated temperature) sufficient to remove the solvent or latex continuous phase.

The binder/particle mixture may be cast onto or around a support (which may also function as a current collector) or into a form. The binder particle mixture may be impregnated into various types of mechanical reinforcing structures, such as meshes, fibers, and the like, in order to provide greater mechanical strength to the electrode. Upon removing the solvent or carrier fluid, the electrode particles become bound together by the binder to form a solid electrode. The electrode is often significantly porous.

Other particulate materials may be incorporated into the cathode. These include conductive materials such as carbon particles, carbon nanotubes and the like.

A battery of the invention includes a cathode as described above, an anode, a separator disposed between the anode and cathode, and an electrolyte solution containing at least one lithium salt, said electrolyte solution being in contact with the anode and cathode

The anode material is one that can reversibly intercalate lithium ions during a battery charging cycles and release lithium ions into a battery electrolyte solution (with production of electrons) during a battery discharge cycle. Suitable anode materials include, for example, carbonaceous materials such as natural or artificial graphite, carbonized pitch, carbon fibers, graphitized mesophase microspheres, furnace black, acetylene black and various other graphitized materials. Other materials such as lithium, silicon, germanium and molybdenum oxide are useful anode materials. Particles can contain two or more of these anode materials. In addition, mixtures of two or more types of anode material particles can be used.

The separator is interposed between the anode and cathode to prevent the anode and cathode from coming into contact with each other and short-circuiting. The separator is conveniently constructed from a nonconductive material. It should not be reactive with or soluble in the electrolyte solution or any of the components of the electrolyte solution under operating conditions. Polymeric separators are generally suitable. Examples of suitable polymers for forming the separator include polyethylene, polypropylene, polybutene-1, poly-3-methylpentene, ethylene-propylene copolymers, polytetrafluoroethylene, polystyrene, polymethylmethacrylate, polydimethylsiloxane, polyethersulfones, polyamides, and the like.

The electrolyte solution must be able to permeate through the separator. For this reason, the separator is generally porous, being in the form of a porous sheet, nonwoven or woven fabric or the like. The porosity of the separator is generally 20% or higher, up to as high as 90%. A preferred porosity is from 30 to 75%. The pores are generally no larger than 0.5 microns, and are preferably up to 0.05 microns in their longest dimension. The separator is typically at least one micron thick, and may be up to 50 microns thick. A preferred thickness is from 5 to 30 microns.

The basic components of the battery electrolyte solution are a lithium salt and a nonaqueous solvent for the lithium salt. The lithium salt may be any that is suitable for battery use, including inorganic lithium salts such as LiAsFG, LiPF₆, LiB(C₂O₄)₂, LiBF₄, LiBF₂C₂O₄, LiClO₄, LiBrO₄ and LiIO₄ and organic lithium salts such as LiB(C₆H₅)₄, LiCH₃SO₃, LiN(SO₂C₂F5)₂ and LiCF₃SO₃. LiPF₆, LiClO₄, LiBF₄, LiAsFG, LiCF₃SO₃ and LiN(SO₂CF₃)₂ are preferred types, and LiPF6 is an especially preferred lithium salt.

The lithium salt is suitably present in a concentration of at least 0.5 moles/liter of electrolyte solution, preferably at least 0.75 moles/liter, up to 3 moles/liter and more preferably up to 1.5 moles/liter.

The nonaqueous solvent may include, for example, one or more linear alkyl carbonates, cyclic carbonates, cyclic esters, linear esters, cyclic ethers, alkyl ethers, nitriles, sulfones, sulfolanes, siloxanes and sultones. Mixtures of any two or more of the foregoing types can be used. Cyclic esters, linear alkyl carbonates, and cyclic carbonates are preferred types of nonaqueous solvents.

Suitable linear alkyl carbonates include dimethyl carbonate, diethyl carbonate, methyl ethyl carbonate and the like. Cyclic carbonates that are suitable include ethylene carbonate, propylene carbonate, butylene carbonate and the like. Suitable cyclic esters include, for example, y-butyrolactone and y-valerolactone. Cyclic ethers include tetrahydrofuran, 2-methyltetrahydrofuran, tetrahydropyran and the like. Alkyl ethers include dimethoxyethane, diethoxyethane and the like. Nitriles include mononitriles such as acetonitrile and propionitrile, dinitriles such as glutaronitrile, and their derivatives. Sulfones include symmetric sulfones such as dimethyl sulfone, diethyl sulfone and the like, asymmetric sulfones such as ethyl methyl sulfone, propyl methyl sulfone and the like, and their derivatives. Sulfolanes include tetramethylene sulfolane and the like. Various other additives may be present in the battery electrolyte solution. These may include, for example, additives which promote the formation of a solid electrolyte interface at the surface of a graphite electrode; various cathode protection agents; lithium salt stabilizers; lithium deposition improving agents; ionic solvation enhancers; corrosion inhibitors; wetting agents; flame retardants; and viscosity reducing agents. Many additives of these types are described by Zhang in “A review on electrolyte additives for lithium-ion batteries”, J. Power Sources 162 (2006), pp. 1379-1394.

Agents that promote solid electrolyte interphase (SEI) formation include various polymerizable ethylenically unsaturated compounds and various sulfur compounds, as well as other materials. Suitable cathode protection agents include materials such as N,N-diethylaminotrimethylsilane and LiB(C₂O₄)₂. Lithium salt stabilizers include LiF, tris(2,2,2-trifluoroethyl)phosphite, 1-methyl-2-pyrrolidinone, fluorinated carbamate and hexamethylphosphoramide. Examples of lithium deposition improving agents include sulfur dioxide, polysulfides, carbon dioxide, surfactants such as tetraalkylammonium chlorides, lithium and tetraethylammonium salts of perfluorooctanesulfonate, various perfluoropolyethers and the like. Crown ethers can be suitable ionic solvation enhancers, as are various borate, boron and borole compounds. LiB(C₂O₄)₂ and LiF₂C₂O₄ are examples of aluminum corrosion inhibitors. Cyclohexane, trialkyl phosphates and certain carboxylic acid esters are useful as wetting agents and viscosity reducers. Some materials, such as LiB(C₂O₄)₂, may perform multiple functions in the electrolyte solution.

The various other additives may together constitute up to 20%, preferably up to 10% of the total weight of the battery electrolyte solution. The water content of the resulting battery electrolyte solution should be as low as possible. A water content of 50 ppm or less is desired and a more preferred water content is 30 ppm or less.

The battery is preferably a secondary (rechargeable) lithium battery. In such a battery, the discharge reaction includes a dissolution or delithiation of lithium ions from the anode into the electrolyte solution and concurrent incorporation of lithium ions into the cathode. The charging reaction, conversely, includes an incorporation of lithium ions into the anode from the electrolyte solution. Upon charging, lithium ions are reduced on the anode side, at the same time, lithium ions in the cathode material dissolve into the electrolyte solution.

The battery of the invention can be used in industrial applications such as electric vehicles, hybrid electric vehicles, plug-in hybrid electric vehicles, aerospace, e-bikes, etc. The battery of the invention is also useful for operating a large number of electrical and electronic devices, such as computers, cameras, video cameras, cell phones, PDAs, MP3 and other music players, televisions, toys, video game players, household appliances, power tools, medical devices such as pacemakers and defibrillators, among many others.

The following examples are intended to illustrate the invention, but not to limit the scope thereof. All parts and percentages are by weight unless otherwise indicated.

### EXAMPLE 1

A lithium rich layered oxide cathode material (Li_{1.2}Ni_{0.17}Mn_{0.56}Co_{0.07}O₂) is prepared by firing a mixture of lithium carbonate and Ni, Mn, Co mixed carbonate at 850° C. for 10 hours in air. The cathode material is mixed with polyamic acid solution in N-methyl pyrrolidone. Ratios are such that 0.5 parts of the polyamic acid are combined with 100 parts the cathode material. The polyamic acid is a trimellitic dianhydride-4,4′-oxydiphenylamine condensation product sold by DuPont as Kapton™ K. The material is mixed vigorously for one hour to produce a uniform coating of the polyamic acid onto the particles. The coated particles are then filtered and dried under vacuum at 30° C. overnight to remove the solvent.

The coated cathode material is then heated to 200° C. under nitrogen to partially imidize the polyamic acid. IR analysis indicates approximately one-half of the carboxylic acid groups are consumed during this partial imidization step.

The partially imidized cathode material is divided into two halves. One half is heated to 400° C. under nitrogen to fully imidize the sample. No detectable carboxylic acid groups remain after this imidization step. The resulting polyimide-coated cathode material is designated as Comparative Sample A.

The other half is reacted with 4-amino-2,2,6,6-tetramethylpyridine-l-oxyl at room temperature for 72 hours. The attachment of the stable free radical is confirmed by the presence of an N—O* stretch peak on infrared analysis. The resulting free-radical-containing coated cathode material is designated as Example 1. The Example 1 material has an equivalent weight of about 1000 per stable free radical group.

Example 1, Comparative Sample A and the uncoated cathode material (Comparative Sample B) are separately formed into electrodes by following procedure. The cathode material is mixed under with SUPER P™ carbon black (Timcal Americas Inc., Westlake, Ohio), VGCF™ vapor grown carbon fiber (Showa Denko K.K. Japan) and polyvinylidene fluoride (PVDF) (Arkema Inc., King of Prussia, Pa.) binder in a weight ratio of cathode material:SuperP:VGCF:PVDF of 90:2.5:2.5:5. A slurry is prepared by suspending the cathode material, conducting material, and binder in N-methyl-2-pyrrolidone (NMP) followed by homogenization in a vacuum speed mixer. The NMP to solids ratio is approximately 1.6:1 before defoaming under mild vacuum evaporation. Using a doctor blade, the slurry is coated onto battery grade aluminum foil (15 mm thickness) to an approximate thickness of 30 micrometers. The applied slurry film is dried for thirty minutes at 130° C. in a convection oven. The electrodes are designated Electrode Example 1, Electrode Comparative Sample A and Electrode Comparative Sample B, respectively.

The performance of the electrode materials is evaluated in half cells. 2025 coin-type half cells are assembled, using lithium foil disks as the counter electrodes. Cell rate testing is performed according to the following protocol:

LRM Half Cell Rate Test
5 hours Rest

| | | | | | | |
|---|---|---|---|---|---|---|
| Forma- | 1st | Charge | CCCV | 0.05 | C | 4.6 V - 0.01 C Cut |
| tion | Cycle | Discharge | CC | 0.05 | C | 2.0 V Cut |
| C-Rate | 2nd | Charge | CCCV | 0.1 | C | 4.6 V - 0.01 C Cut |
| Test | Cycle | Discharge | CC | 0.1 | C | 2.0 V Cut |
| | 3rd | Charge | CCCV | 0.2 | C | 4.6 V - 0.01 C Cut |
| | Cycle | Discharge | CC | 0.2 | C | 2.0 V Cut |
| | 4th | Charge | CCCV | 0.2 | C | 4.6 V - 0.01 C Cut |
| | Cycle | Discharge | CC | 0.33 | C | 2.0 V Cut |
| | 5th | Charge | CCCV | 0.2 | C | 4.6 V - 0.01 C Cut |
| | Cycle | Discharge | CC | 1 | C | 2.0 V Cut |
| | 6th | Charge | CCCV | 0.2 | C | 4.6 V - 0.01 C Cut |
| | Cycle | Discharge | CC | 3 | C | 2.0 V Cut |
| | 7th | Charge | CCCV | 0.2 | C | 4.6 V - 0.01 C Cut |
| | Cycle | Discharge | CC | 5 | C | 2.0 V Cut |
| Cycling | 8-9 | Charge | CCCV | 0.1 | C | 4.6 V - 0.05 C Cut |
| | Cycles | Discharge | CC | 0.1 | C | 2.0 V Cut |
| | 10-32 | Charge | CCCV | 0.33 | C | 4.6 V - 0.05 C Cut |
| | Cycles | Discharge | CC | 1 | C | 2.0 V Cut |
| | 33-34 | Charge | CCCV | 0.1 | C | 4.6 V - 0.05 C Cut |
| | Cycles | Discharge | CC | 0.1 | C | 2.0 V Cut |
| | 35-57 | Charge | CCCV | 0.33 | C | 4.6 V - 0.05 C Cut |
| | Cycles | Discharge | CC | 1 | C | 2.0 V Cut |
| | 58-59 | Charge | CCCV | 0.1 | C | 4.6 V - 0.05 C Cut |
| | Cycles | Discharge | CC | 0.1 | C | 2.0 V Cut |
| | 60-107 | Charge | CCCV | 0.33 | C | 4.6 V - 0.05 C Cut |
| | Cycles | Discharge | CC | 1 | C | 2.0 V Cut |

The initial charge capacity, and discharge capacities at O.1C, 0.33C, 1C, 3C, 5C and again at O.1C are measured at the 2^{nd}, 4^{th}, 5^{th}, 6^{th}, 7^{th}, and 8^{th} cycles, respectively. Results are in Table 1 below. Values are the average of triplicate samples.

TABLE 1

| Test | Ex. 1 | Comp. Sample A | Comp. Sample B |
|---|---|---|---|
| Charge capacity, mAh/g | 309 | 307 | 304 |

Discharge Capacity mAh/g

| | | | | |
|---|---|---|---|---|
| 0.1 | C (1^{st} cycle) | 287 | 280 | 284 |
| 0.33 | C (4^{nd} cycle) | 277 | 267 | 273 |
| 1 | C (5^{th} cycle) | 263 | 251 | 258 |
| 3 | C (6^{th} cycle) | 244 | 225 | 235 |
| 5 | C (7^{th} cycle) | 229 | 205 | 214 |
| 0.1 | C (8^{th} cycle) | 282 | 274 | 278 |

| | | | |
|---|---|---|---|
| Ratio, 5 C/0.1 C | 0.81 | 0.75 | 0.77 |
| (7^{th}/8^{th} cycles) | | | |

These results show that the charge capacity of Example 1 is slightly higher than either of the comparative samples. On the first discharge cycle (0.1C), discharge capacities are similar for all three electrode materials. However, at higher discharge rates, the discharge capacity of Example 1 is about 6-12% higher than the Comparative Samples. This result is indicative of significantly better high discharge rate performance. Note that the polyimide coating by itself causes a slight deterioration in both charge and discharge capacities, relative to the control (Comparative Sample B) that does not have a coating. The addition of stable free radicals to the coating (Ex. 1) not only overcomes the detrimental effects of the polyimide, but leads to a significant improvement in rate performance.

The specific capacity of the three samples is measured at the 9th and 58th cycle. Results are as indicated in Table 2.

TABLE 2

| Specific Capacity, | | | |
|---|---|---|---|
| mAh/g | Ex. 1 | Comp. Sample A | Comp. Sample B |
| 9^{th} cycle | 255 | 245 | 255 |
| 58^{th} cycle | 230 | 210 | 188 |

This data shows that the specific capacity of Example 1 at the 8th cycle is essentially the same as the uncoated control (Comp. Sample B). The polyimide-coated cathode material has a slightly lower specific capacity at the 9th cycle. After 50 more cycles, the Example 1 cathode has lost 10% of its capacity after the 9th cycle, whereas the control has lost about 26% of its 9th cycle capacity. Comp. Sample A, which has the polyimide-coated cathode material, has lost 14% of its 9th cycle capacity, with the absolute values being lower than those of Example 1.

The mean voltage discharge is also measured at the 9th and 58th cycles, with results as indicated in Table 3.

TABLE 3

| Average Discharge | | | |
|---|---|---|---|
| Voltage (V) | Ex. 1 | Comp. Sample A | Comp. Sample B |
| 9^{th} cycle | 3.44 | 3.43 | 3.42 |
| 58^{th} cycle | 3.30 | 3.33 | 3.22 |

As can be seen from the data in Table 3, Example 1 retains its average discharge voltage much better than Comparative Sample B (the uncoated cathode material).

Full cells are prepared using each of the Example 1 and Comparative Sample B cathode materials. The cells are evaluated by hybrid pulse power characterization (HPPC) to determine cell's dynamic power capability over its useable state of charge (SOC) and depth of discharge (DOD) range. On the initial cycle, Example 1 exhibits a higher cell resistance/impedance than the control (Comp. Sample B) at a depth of discharge below 60%, but a smaller resistance/impedance at higher depth of discharge. The cathode voltage is 3.4V at 60% DOD. After 50 cycles, the resistance/impedence of the control increases significantly, whereas that of Example 1 has deceased. After 50 cycles, the resistance/impedence of Example 1 is lower than that of Comparative Sample B across the entire range of depth of discharge.

### EXAMPLES 2-4

A lithium rich layered oxide cathode material is coated with a polyamic acid solution as described in Example 1.

The coated material is heated in an oven at the rate of 5° C./minute to 60° C., and held at 60° C. for 30 minutes. A first portion is removed from the oven; IR analysis of this portion indicates approximately 25% of the carboxylic acid groups have been consumed. The remainder is heated to 120° C. at the rate of 5° C/minute and held at 120° C. for 30 minutes. A second portion is removed from the oven, and is found to be approximately 40% imidized. The remainder is heated further to 200° C. at the rate of 5° C/minute and held at 200° C. for 30 minutes. A third portion is removed from the oven and is found to be about 53% imidized.

Each of the partially imidized materials are reacted with 4-amino-2,2,6,6-tetramethylpyridine-l-oxyl at room temperature for 72 hours to produce Examples 2-4, respectively. The approximate equivalent weights per stable free radical group for Examples 2-4 are approximately 685, 805 and 994, respectively.

The performances of Examples 2-4 are evaluated in half-cells as described in Example 1. The performance of the uncoated cathode material (Comp. Sample C) is evaluated as for comparison. Results are as indicated in Table 4.

TABLE 4

| Property | Ex. 2 | Ex. 3 | Ex. 4 | Comp. Sample C |
|---|---|---|---|---|
| Specific Capacity, 8^{th} | 258 | 248 | 242 | 235 |
| cycle, mAh/g | | | | |
| Specific Capacity, 80^{th} | 245 | 238 | 238 | 215 |
| cycle, mAh/g | | | | |
| % Capacity loss, | 5% | 4% | 1.65% | 8.5% |
| 8^{th}-80^{th} cycle | | | | |
| Average discharge | 3.531 | 3.523 | 3.527 | 3.541 |
| voltage, first 0.1 C | | | | |
| discharge cycle | | | | |
| Average discharge | 3.472 | 3.472 | 3.470 | 3.466 |
| voltage, 50^{th} 0.1 C | | | | |
| discharge cycle | | | | |
| Voltage loss, | 59 | 51 | 57 | 75 |
| 1^{st}-50^{th} 0.1 C | | | | |
| discharge cycle, mV | | | | |
| Average Energy | 900 | 848 | 855 | 825 |
| Density, Wh/kg, | | | | |
| 8^{th} cycle | | | | |
| Average Energy | 830 | 780 | 780 | 735 |
| Density, Wh/kg, | | | | |
| 80^{th} cycle | | | | |
| % Energy Density | 7.8% | 8% | 8.8% | 10.9% |
| Loss, 8^{th}-80^{th} cycle | | | | |

Examples 2-4 have higher specific capacities than the control, and lose specific capacity at a slower rate than the control. The control also loses voltage and energy density faster than any of Examples 2-4.

Examples 2-4 show the effect of varying the amount of stable free radicals in the coating. Example 2, which contains the most stable free radicals per unit weight, performs significantly better than Examples 3 and 4.

1. A particulate cathode material comprising particles of an electroactive lithium transition metal cathode material, the particles having stable free radical groups bonded to a polyimide coating on the surface of the particles.

2-4. (canceled)

5. The particulate cathode material of claim 1 wherein the polyimide is a condensation product of pyromellitic dianhydride and 4,4′-oxydiphenylamine.

6. The particulate cathode material of claim 1 wherein the polyimide coating has an equivalent weight of 500 to 1200 per stable free radical group.

7. The particulate cathode material of claim 1 wherein the stable free radicals are nitroxide free radical groups.

8. The particulate cathode material of claim 7 wherein the nitroxide free radical groups include 2,2,6,6, -tetramethylpiperidine 1-oxyl groups.

9. The particulate cathode material of claim 1 wherein the lithium transition metal cathode material is a lithium-rich layered oxide having the formula xLi₂MnO₃. (1-x) LiMO₂ wherein M is one or more third row transition metals.

10. A battery cathode comprising the coated particulate cathode material ofclaim 1.

11. A lithium battery comprising an anode, a battery cathode of claim 10, a separator disposed between the anode and cathode, and an electrolyte solution containing at least one lithium salt, said electrolyte solution being in contact with the anode and cathode.

12-13. (canceled)

14. A method for making the coated particulate cathode material of claim 1, comprising;
a) applying a polyamic acid coating polymer having carboxylic acid and amido groups onto the surface of particles that contain an electroactive lithium transition metal cathode material and
b) reacting a portion of the carboxylic acid and/or amido groups of the polyamic acid coating the polymer with a functionalized stable free radical compound having a stable free radical or a free radical precursor group and a functional group, wherein the functional group and a portion of the carboxylic acid and/or amide groups react to bond stable free radical groups or free radical precursor groups to the polymer polyamic acid coating, imidizing some or all of the remaining carboxylic acid and amido groups to form a polyimide, and then converting any free radical precursor groups to stable free radical groups.

15. (canceled)
